(19) United States
(12) Patent Application Publication
(10) Pub. No.: US 2018/0328496 A1
(43) Pub. Date: Nov. 15, 2018

(54) FLOW DIFFUSER VALVE AND SYSTEM

(71) Applicants: Hai Hoang Nguyen, Houston, TX (US); Darrin Willauer, The Woodlands, TX (US)

(72) Inventors: Hai Hoang Nguyen, Houston, TX (US); Darrin Willauer, The Woodlands, TX (US)

(73) Assignee: Baker Hughes Incorporated, Houston, TX (US)

(21) Appl. No.: 15/591,210

(22) Filed: May 10, 2017

(51) Int. Cl. F16K 3/02; F16K 1/42

(52) U.S. Cl. CPC F16K 3/0209; E21B 21/103; F16K 1/427

(57) ABSTRACT

A diffuser valve including a housing having a housing porta closure member in operable communicating with the housing, the member having a member port, a diffuser having at least a body exhibiting porosity configured to reduce a fluid flow rate through the body, the diffuser disposed within a flow path between the housing port and the member port. A borehole system including a tubing string disposed in a borehole, a diffuser valve having a housing having a housing port, a closure member in operable communicating with the housing, the member having a member port, a diffuser having at least a body exhibiting porosity configured to reduce a fluid flow rate through the body, the diffuser disposed within a flow path between the housing port and the member port.

### BACKGROUND

In the subsurface resource recovery industry, and especially where boreholes are used in operations, tubing strings are employed to reach into the subsurface environment to drill the borehole, treat a formation, effect completion operations and for production. In each of these operations there is often a need to isolate fluid from tubing ID to annulus and then often a need to allow fluid to flow between tubing ID and annulus. Valves have been used to open a fluid pathway between the tubing ID and annulus for this purpose. Because there may be a pressure differential across whatever valve is being used to isolate or fluidly connect these spaces, there is a risk of flow cutting of any seals used as part of the valve. Flow cutting occurs because of fluid flow velocity the moment a pathway is presented when there has been differential pressure across the valve. The greater the differential pressure and the larger the pathway, the higher the fluid velocity and hence the greater the potential for fluid cutting. The art will well receive alternative configurations that reduce flow cutting in valves opened across differential pressure.

### SUMMARY

A diffuser valve including a housing having a housing porta closure member in operable communicating with the housing, the member having a member port, a diffuser having at least a body exhibiting porosity configured to reduce a fluid flow rate through the body, the diffuser disposed within a flow path between the housing port and the member port.

A borehole system including a tubing string disposed in a borehole, a diffuser valve having a housing having a housing port, a closure member in operable communicating with the housing, the member having a member port, a diffuser having at least a body exhibiting porosity configured to reduce a fluid flow rate through the body, the diffuser disposed within a flow path between the housing port and the member port.

### BRIEF DESCRIPTION OF THE DRAWINGS

The following descriptions should not be considered limiting in any way. With reference to the accompanying drawings, like elements are numbered alike:

FIG. 1 is a schematic cross section view of a sliding sleeve type valve with a diffuser as disclosed herein;

FIG. 2 is a schematic cross section view of an embodiment of the diffuser as disclosed herein; and

FIG. 3 is a borehole system employing one or more valves as described herein.

### DETAILED DESCRIPTION

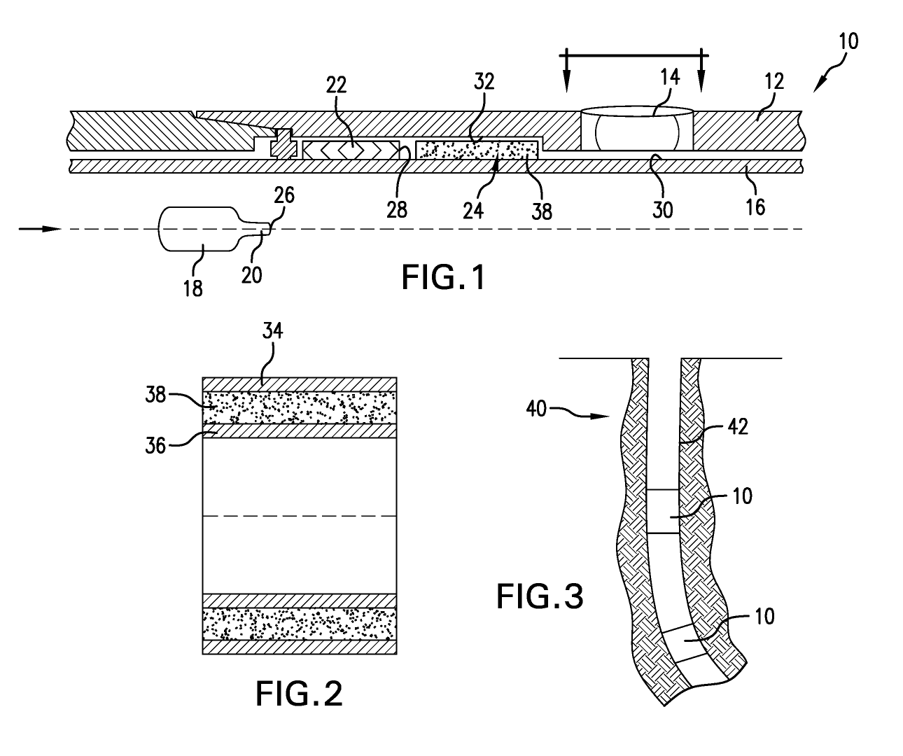

Referring to FIG. 1, a valve 10 is illustrated as a sliding sleeve valve comprising a housing 12 defining a housing port 14. Disposed in operable communication with the housing 12 is a closure member 16 illustrated in FIG. 1 (one embodiment) as a sliding sleeve. The closure member 16 defines a closure member port 18. The port 18 may be configured in some embodiments with a nose 20 whose function it is to reduce flow cutting of a valve seal. In view of other components of valve embodiments disclosed herein, the functionality of the nose 20 is largely superfluous though embodiments hereof may still use the nose 20 and benefit therefrom. Between the housing 12 and the sleeve 16 is a seal 22, the flow cutting of which during opening of the valve 10 in differential pressure conditions across the valve 10 is the problem for which the disclosure hereof tenders a solution. The nose 20 is helpful because the nose presents a smaller flow area initially presented as the port first exits the seal 22 than would be presented if the port 18 did not include the nose 20. Between the seal 22 and the port 14 is a diffuser 24 whose function it is to protect the seal 22 from the flow cutting to which reference has been made above.

In discussing flow cutting and as noted above, it will be understood by those of skill in the art that immediately upon the smallest flow path opening between fluid volumes of different pressure there will be fluid movement. The volume of fluid moving through that flow path is dictated in part by the differential pressure and in part by the flow area available. In the FIG. 1 embodiment illustrated, this the flow path first occurs when a tip 26 of the nose 20 first clears an end wall 28 of the seal 22 whereafter but for the diffuser discussed hereunder, the full effect of whatever the differential pressure is would be incurred in that pathway. And where differential pressure is high, that flow would be energetic and fully capable of damaging the seal 22. Controlling the ability of fluid to flow at any significant velocity under differential pressure allows for reduction of the differential pressure over a relatively short period of time after which the valve 10 may be fully opened without concern for flow cutting.

Still referring to FIG. 1, and focusing upon diffuser 24, one will note that it is positioned between the seal 22 and the port 14. In this position, it is an impediment to fluid flow between port 18 and port 14. An impediment will slow fluid flow and hence reduce or prevent flow cutting of the seal 22. More specifically, the diffuser is configured to very closely mate an outside diameter surface 30 of the sleeve 16 and may be sealed to, bonded to or formed with a portion 32 of the housing 12. This ensures there is little to no flow path around the diffuser 24 such that fluid making its way from port 14 to port 18 will have to travel through the diffuser 24. It will be appreciated that if there is a large gap between the diffuser 24 and the surface 30, fluid would be able to rush through that space and largely avoid the diffuser to the detriment of the seal 22. Hence it is important for the interface between the diffuser 24 and the surface 30 to be fluid flow inhibiting. This may simply be by maintaining the gap quite small based upon manufacturing tolerances or may be aided in some way by additional sealing members or coatings on the diffuser 24 such as elastomeric coatings. It is also contemplated that coatings on the diffuser may include anti-galling coatings, anti-friction coatings, etc. Coatings, illustrated with numerals 34 and 36 represent generically possible coatings and can be seen in FIG. 2.

The diffuser 24 comprises a diffuser body 38 that is visible in both figures. The body 38 comprises a porous constitution that provides for fluid passage but with relatively high fluidic friction so that fluid flow therethrough is slowed. The degree to which the fluid flow rate can be characterized as slow depends upon the particular application and relates to the potential differential pressure the valve might experience at a time when it is to be opened. The point, which is evident from the foregoing, is that the pressure differentially driven fluid flow will be slowed to a velocity that will not significantly damage the seal 22. Degree of porosity or tortuosity of the pores is adjustable during creation/manufacture of the body 38. Deciding on what that porosity or tortuosity should be for a particular application is resolved by experiment at the pressure differential expected and the flow area provided in a specific embodiment. It will be appreciated that a low porosity or high tortuosity of the body 38 will work for nearly all iterations as fluid flow will be substantially hindered in such configurations but the system may require a longer period of time for the differential pressure across the valve 10 to equalize and hence cause delay in fully opening the valve 10. This is why testing and experimentation on exact porosity/tortuosity would be helpful for particular embodiments as by such activities it can be determined just how much slowing of fluid flow and over what period of time is needed to reach equilibrium as far as pressure differential goes which then allows an operator to shift the valve to full open.

It is to be appreciated that in embodiments, the diffuser 24 may be configured independently of the housing 12 or may be a part of the housing 12. Methods of producing porous structures include one or more of but are not limited to-powder compression, extrusion, deposition and sintering. Further, additive manufacture may be used to produce any portion of the valve 10 from just the body 38 of diffuser 24 up to the entirety of the valve 10. Additive manufacture provides a benefit to control of the degree of porosity and or the tortuosity of pores through the body 38 so that tailoring a particular diffuser to a particular application is a simple matter and facilitates a degree of tailoring that optimizes the time to fluid velocity control ratio when opening a valve 10 so that a seal 22 is fully protected while the valve 10 may be fully opened as quickly as possible.

Borehole systems 40 that employ one or more valves 10 as part of a tubing string 42 as described herein enjoy reduced flow cutting problems, reduced maintenance issues, better sealing in the valves 10 and more rapid valve opening operations where differential pressure exists across the valve.

Set forth below are some embodiments of the foregoing disclosure:

### Embodiment 1

A diffuser valve including a housing having a housing port, a closure member in operable communication with the housing, the member having a member port, a diffuser having at least a body exhibiting porosity configured to reduce a fluid flow rate through the body, the diffuser disposed within a flow path between the housing port and the member port.

### Embodiment 2

The valve as in any prior embodiment wherein the diffuser is sealed to the housing.

### Embodiment 3

The valve as in any prior embodiment wherein the diffuser is bonded to the housing.

### Embodiment 4

The valve as in any prior embodiment wherein the diffuser is a part of the housing.

### Embodiment 5

The valve as in any prior embodiment wherein the diffuser further includes a seal to the closure member.

### Embodiment 6

The valve as in any prior embodiment wherein the seal is a coating.

### Embodiment 7

The valve as in any prior embodiment wherein the coating is one or both of an anti-galling material and an anti-friction material.

### Embodiment 8

The valve as in any prior embodiment wherein the member is a sliding sleeve.

### Embodiment 9

The valve as in any prior embodiment wherein the member port includes a nose.

### Embodiment 10

A borehole system including a tubing string disposed in a borehole, a diffuser valve having a housing having a housing port, a closure member in operable communication with the housing, the member having a member port, a diffuser having at least a body exhibiting porosity configured to reduce a fluid flow rate through the body, the diffuser disposed within a flow path between the housing port and the member port.

### Embodiment 11

The borehole system as claimed in claim 10 wherein the diffuser valve is one or more diffuser valves.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A diffuser valve comprising:
a housing having a housing port;
a closure member in operable communication with the housing, the member having a member port;
a diffuser having at least a body exhibiting porosity configured to reduce a fluid flow rate through the body, the diffuser disposed within a flow path between the housing port and the member port.

2. The valve as claimed in claim 1 wherein the diffuser is sealed to the housing.

3. The valve as claimed in claim 1 wherein the diffuser is bonded to the housing.

4. The valve as claimed in claim 1 wherein the diffuser is a part of the housing.

5. The valve as claimed in claim 1 wherein the diffuser further includes a seal to the closure member.

6. The valve as claimed in claim 5 wherein the seal is a coating.

7. The valve as claimed in claim 5 wherein the coating is one or both of an anti-galling material and an anti-friction material.

8. The valve as claimed in claim 1 wherein the member is a sliding sleeve.

9. The valve as claimed in claim 1 wherein the member port includes a nose.

10. A borehole system comprising:
a tubing string disposed in a borehole;
a diffuser valve having:
a housing having a housing port;
a closure member in operable communication with the housing, the member having a member port;
a diffuser having at least a body exhibiting porosity configured to reduce a fluid flow rate through the body, the diffuser disposed within a flow path between the housing port and the member port.

11. The borehole system as claimed in claim 10 wherein the diffuser valve is one or more diffuser valves.
